(19) United States
(12) Patent Application Publication
(10) Pub. No.: US 2005/0145817 A1
(43) Pub. Date: Jul. 7, 2005

(54) Ball valve construction and method for use in 150 PSI and 300 WOG applications

(75) Inventors: Douglas M. Corp, Sanford, FL (US); William T. Corp JR., Longwood, FL (US); Roy S. Jacobs, Greensboro, NC (US)

Correspondence Address: Carl M. Napolitano;Allen, Dyer, Doppelt, Milbrath & Gilchrist, P.A., Suite 1401, 255 South Orange Avenue, Orlando, FL, 32801, US

(73) Assignee: DRW Holdings, LLC, Sanford, FL (US)

(21) Appl. No.: 11/017,212

(22) Filed: Dec. 17, 2004

Related U.S. Application Data
(60) Provisional application No. 60/531,003, filed on Dec. 19, 2003.

(51) Int. Cl. F16K 31/02; F16K 5/00; F16K 5/06

(52) U.S. Cl. 251/315.03

(57) ABSTRACT

A ball valve is fabricated with a ductile iron or carbon steel ball. The ball is coated with a corrosive resistant coating assimilated the ball surface with the coating having a thickness ranging from two to six mils.

### CROSS-REFERENCE TO RELATED APPLICATIONS

This application claims the benefit of U.S. Provisional Application No. 60/531,003, filed Dec. 19, 2003, of which is hereby incorporated herein in its entirety by reference.

### FIELD OF THE INVENTION

The present invention relates to the field of valves and in particular to valves having corrosion resistant valve elements.

### BACKGROUND OF THE INVENTION

A variety of materials have been used in ball valves in the past for different applications. Typically, valves having steel balls are used in higher end applications, while cast iron and lower grade materials have been used for low end applications. In U.S. Pat. No. 5,141,018 to Guterman, a ball valve fabricated of cast iron with a corrosion-resistant coating is disclosed. The thickness of the coating disclosed in the '018 patent is not set out in any detail; however, the nature of cast iron requires a relatively thick coating than might otherwise be desirable in certain applications. Further, cast iron has well known limitations.

### SUMMARY OF THE INVENTION

The present invention is directed to a ball valve in which the ball is fabricated of either ductile iron or carbon steel and is provided with a thin protective coating which is assimilated into the surface of the ball valve in order to achieve corrosion resistance.

For purposes of this disclosure, the term “ductile iron” refers to a metal having an iron composition which at least allows usage in the 150 PSI and 300 WOG class applications, and constitutes a tensile strength on the order of 65,000 (compared to that of cast iron at approximately 31,000). The term “carbon steel” refers to a metal closely akin to ductile iron, having a tensile strength on the order of 70,000.

The thickness of the protective coating when a ball valve is fabricated of ductile iron or carbon steel according to this invention is typically on the order of 30% to 70% of the coating thickness for a cast iron ball of the type disclosed in the '018 patent. By way of example, a typical thickness of the coating for a cast iron ball valve is on the order of 8 mils, whereas the thickness of the coating for a ductile iron or carbon steel valve will be on the order of 2-6 mils. Teflon is, of course, a suitable protective coating material.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a cross-sectional view of a typical ball valve of the type useful in connection with the present invention;

FIG. 2 is a perspective illustration, partially cut away, of a ball valve fabricated in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

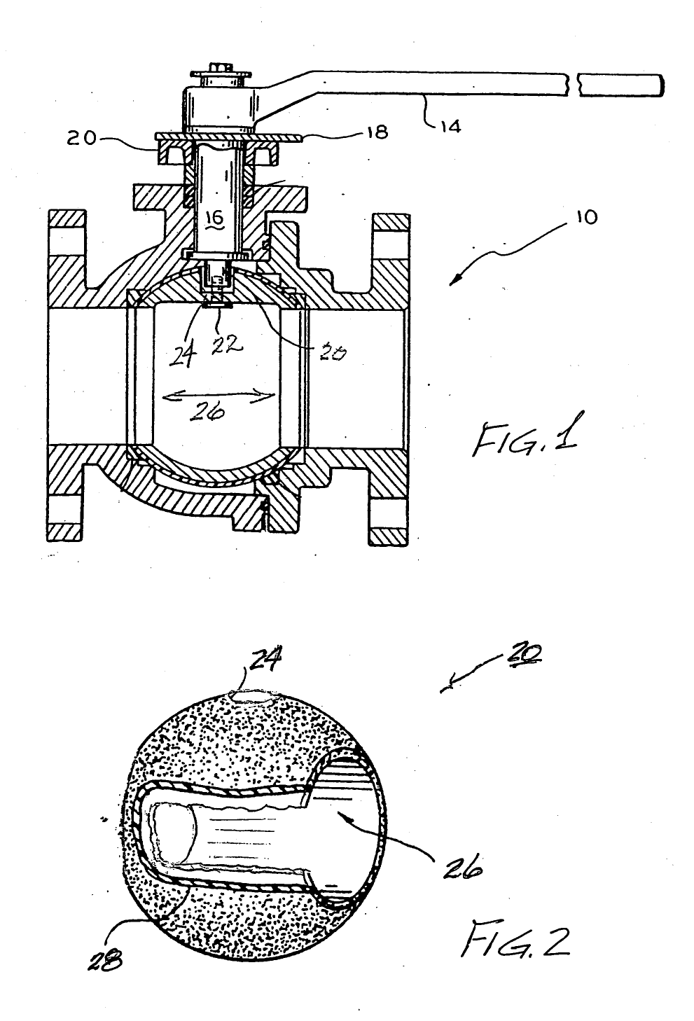

Referring initially to FIGS. 1 and 2, a ball valve is referred to generally by the reference numeral 10 and includes a handle 14 for rotating the ball valve between open and closed positions. The handle 14 is coupled to a stem 16 which extends through a plate 18 and is coupled to the ball valve 20 by a fastener 22 in opening 24.

The construction includes a channel 26 extending through the ball valve 20 in order to permit the passage of fluid when the ball valve 20 is in the open position.

As is shown in FIG. 2, the ball valve 20 includes a coating 28 of Teflon or other appropriate protective material, in order to increase the corrosion and abrasion resistance for the outer surface of the ball 20.

It will be understood and appreciated by those skilled in the art that the combination of either ductile iron or carbon steel with a corrosion-resistant coating disclosed above can be utilized for a variety of valve constructions, and has particular utility in a ball valve setting.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A valve assembly comprising:
a valve housing having a ball operable within a valve seat, the ball having a flow passage extending therethrough, wherein the ball is rotatably operable within the housing and movable between an open position and a closed position relative to the valve seat; and
a corrosion resistant coating covering a surface portion of the ball being wetted during operation thereof, wherein the ball is fabricated from at least one of a ductile iron and a carbon steel, the corrosion resistant coating assimilated into the surface portion of the ball, the coating further having a thickness ranging from 2 mils to 6 mils.
